(19) United States
(12) Patent Application Publication
(10) Pub. No.: US 2008/0177575 A1
(43) Pub. Date: Jul. 24, 2008

(54) Intelligent Image Sets

(75) Inventors: Stewart Higgins, Eindhoven (NL); Bert Verdonck, Retie (BE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 12/065,426

(22) PCT Filed: Aug. 30, 2006
(86) PCT No.: PCT/IB06/53022

§ 371 Date: Feb. 29, 2008

Related U.S. Application Data
(60) Provisional application No. 60/713,183, filed on Aug. 31, 2005.

(51) Int. Cl. G06Q 50/00

(52) U.S. Cl. 705/2

(57) ABSTRACT

A data structure (311) includes one or more of image data (312), presentation data (314), and application software (316). The application software (316) includes functionality which allows a user to view or otherwise manipulate the image data (312). The application software (316) also presents the image data (312) in accordance with the presentation data (314). A user may provide the data structure (311) to one or more recipients, for example over a PACS system (210) or other computer network (106). The data structure (311) is generated by data set generation software (310) based on input parameters (302) such as application information (304), annotation information (305) presentation information (306), data set information (308), and access information (309).

The present invention finds particular application in the field of medical information technology and medical imaging, and particularly to the transmission and manipulation of medical images and data. However, the invention also finds application to the transmission and viewing of non-medical data and images.

Medical imaging systems are increasingly able to provide sophisticated images and other information indicative of the structure and physiology of a patient's anatomy. Examples of currently available medical imaging modalities include magnetic resonance (MR), computed tomography (CT), single photon emission computed tomography (SPECT), positron emission tomography (PET), ultrasound (US), and x-ray (XR). Systems which provide a combination of these modalities (e.g, PET/CT, PET/SPECT systems) have also been developed. Moreover, with ongoing advances in technology and medical research, additional modalities may be developed or refined, for example modalities which exploit advances in molecular diagnostics and imaging.

An ongoing trend in medical imaging has been an increase in the amount and sophistication of the information generated by the various modalities. For example, a single mammography image may be as large as 60 megabytes; a CT scan can easily generate a data set containing a series of 2000 images which, with 16 bit resolution and 512×512 matrix size, can have a size in excess of 1 gigabyte. One consequence of this trend is that the size of the data being generated is becoming increasingly large in relation to the size of the software used to view or otherwise manipulate the data. Another consequence of this trend is that it is increasingly important to simplify the presentation of the information so that a user can more readily locate the portion of the information which is relevant to his or her needs. Yet another consequence is that increasingly sophisticated and often specialized software applications for visualizing and manipulating the information are being developed.

Information generated by a medical imaging system is often presented to the user on one or more computers, such as operator console computers or workstation computers associated with the system. The computer typically includes vendor and modality-specific application software useful for viewing or otherwise manipulating the data generated by that imaging system. This application software can range from simple viewing software to software which provides other functionality such as image processing, presentation, analysis, and/or measurement tools. Again, it is expected that the number, variety, and sophistication of these tools will continue to increase.

Yet another trend has been the increasing availability and use of high speed computer networks and picture archiving and communications (PACS) systems. As a result, the information generated by an imaging system is becoming increasingly accessible to multiple users on multiple computers. These users and their computers may or may not be in the same location, provided by a common vendor, or even affiliated with or owned by a single institution. Moreover, the multiple users may wish to use the information for different purposes, have different user preferences, and the like.

In addition, the digital imaging and communications in medicine (DICOM) standard has been developed as a standard data file format and communication protocol in an attempt to standardize the handling, storage, and transmission of medical image data among computer systems and software applications provided by multiple vendors. The DICOM standard also addresses so-called presentation states which define desired graphics, contrast and brightness, zoom factor, and like parameters for the initial presentation of a data set. DICOM also allows a user to select from a set of DICOM presentation states, provided they have been saved. In theory, at least, a user should be able to access a DICOM data set using so-called DICOM compliant software application and have the data set presented in the desired way. In practice, however, varying interpretations of the DICOM standard can cause variations in how a particular data set is presented. Moreover, providing a DICOM data set does not assure that that the recipient will have the application software needed to view or otherwise manipulate the data set as desired because, for example, some applications require knowledge of private attributes or may not include the desired functionality. Moreover, the presentation states supported by DICOM may be insufficient to define a desired presentation of the data.

Aspects of the present invention address the above matters, and others.

According to a first aspect of the present invention, a method includes the steps of receiving information indicative of desired medical image data, a desired presentation of the medical image data, and a desired application software and generating a computer readable data structure. The data structure includes the desired medical image data, presentation data which specifies the desired presentation of the medical image data, and the desired application software. In operation, the application software presents the desired medical image data in human readable form in accordance with the presentation data.

According to a limited aspect of the invention, the data structure is a self-extracting file.

According to another limited aspect of the invention, the medical image data includes volumetric image data indicative of an interior anatomy of a patient. According to a more limited aspect of the invention, the presentation data includes an orientation for presenting the volumetric image data. The presentation data may include an orientation for presenting a multiplanar reformatted image.

According to another more limited aspect of the invention, the presentation data specifies the presentation of the volumetric image data as a function of time.

According to yet another more limited aspect of the invention, the application software, when in operation, allows a user to deviate from the presentation specified by the presentation data.

According to another limited aspect of the invention, the step of receiving includes receiving presentation information captured during a review of the data set.

According to another limited aspect of the invention, the medical image data includes an image series generated by a medical imaging scanner and the presentation data specifies an order for presenting images contained in the series.

According to still another limited aspect of the invention, the information indicative of a desired application software includes an anatomical region covered by the medical image data.

According to yet another limited aspect of the invention, the method includes transmitting the data structure over a computer network.

According to yet another limited aspect of the invention, the information indicative of the desired presentation includes an acquisition protocol used by a medical imaging scanner to acquire the medical image data.

According to another aspect of the invention, a computer readable storage medium contains instructions which, when executed by a computer, carry out a method which includes the steps of obtaining image data indicative of an interior of an object, generating presentation data which specifies a desired presentation of the image data, obtaining application software which, in operation, presents the image data to a human user in accordance with the presentation data, and generating a data structure which includes the image data, the presentation data, and the application software.

According to a limited aspect of the invention, the image data includes volumetric image data. The application software presents a three dimensional representation of the image data. According to a more limited aspect of the invention, the presentation data includes a path for navigating the three dimensional representation.

According to a more limited aspect of the invention, the method further includes identifying application software used by a user to manipulate the image data. The step of obtaining application software includes obtaining the identified application software.

According to a more limited aspect of the invention, the application software includes a plurality of functions. The method includes identifying a function used by a user to manipulate the image data. The step of obtaining the identified application software includes obtaining the identified function of the application software.

According to another limited aspect of the invention, the step of obtaining image data includes obtaining the image data from a computer readable storage medium.

According to still another limited aspect of the invention, the step of obtaining application software includes obtaining application software selected by a user.

According to yet another limited aspect of the invention, the presentation data specifies a desired presentation of the image data as a function of time.

According to yet another limited aspect of the invention, the application software allows a user to deviate from the desired presentation.

According to still another limited aspect of the invention, the data structure is contained in single computer file. The computer file may be a self-executing file.

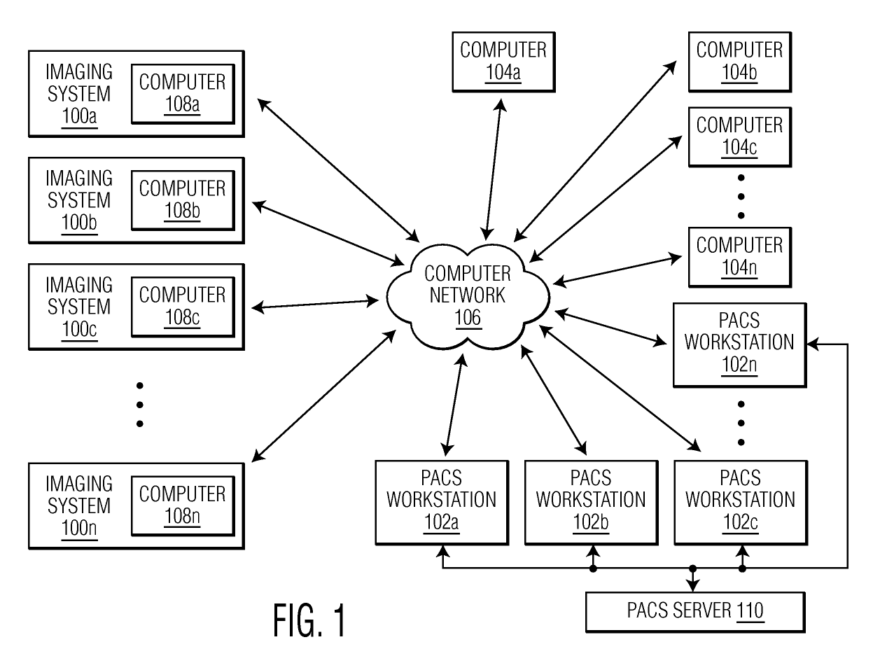

FIG. 1 depicts a plurality of computers in operative communication with a computer network.

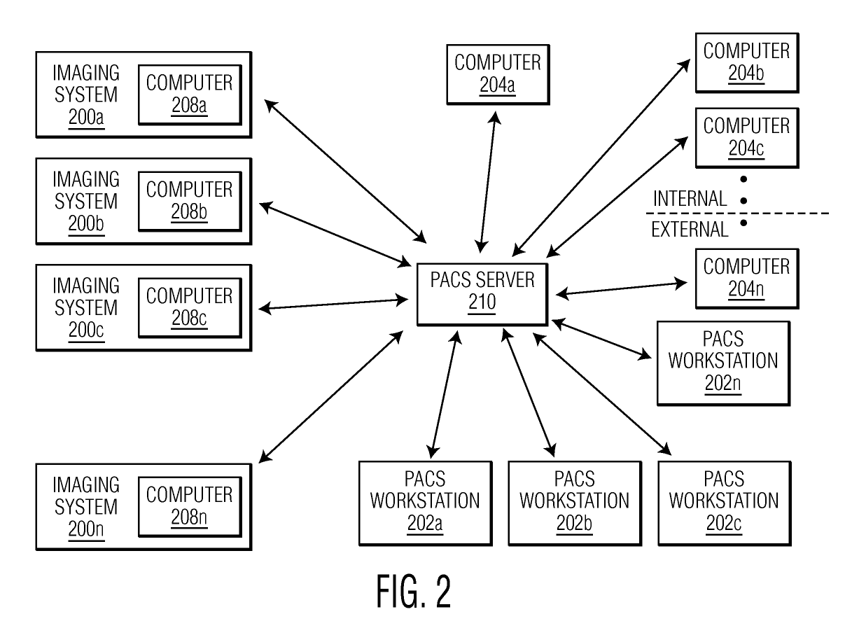

FIG. 2 depicts a plurality of computers in operative communication with a PACS system.

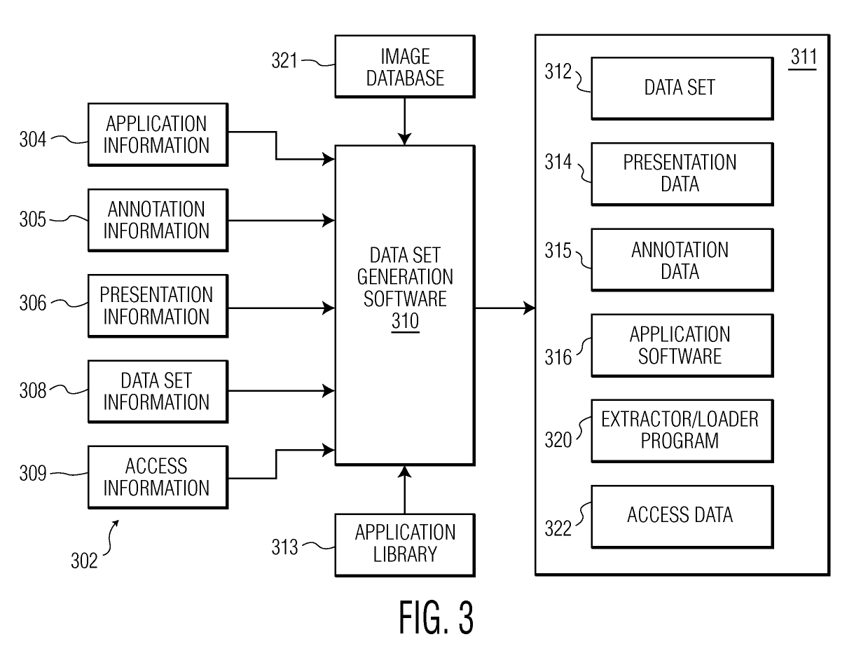

FIG. 3 depicts software for generating a data structure.

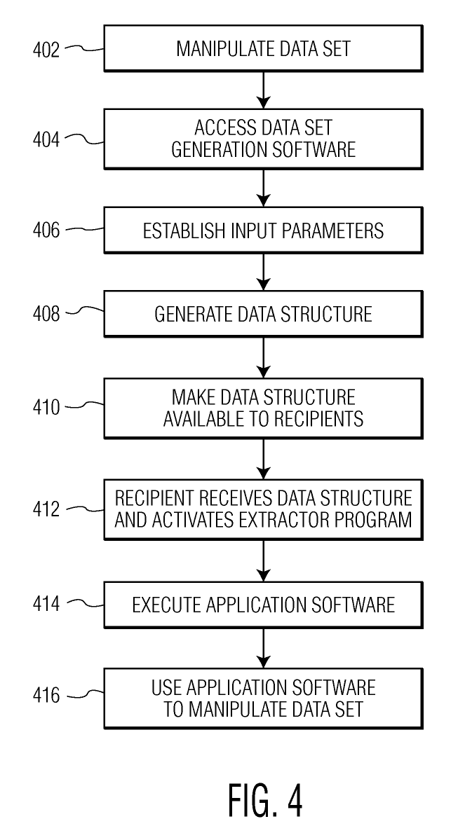

FIG. 4 depicts a technique for generating and accessing a data structure.

With reference to FIG. 1, one or more medical imaging systems 100a, b, c . . . n, picture archiving and communication (PACS) system workstation computers 102a, b, c . . . n, and other computers 104a, b, c . . . n are operatively connected to a computer network 106.

The imaging systems 100a, 100b, 100c . . . 100n may be of different modalities, supplied by different vendors, located in different locations, or even owned by different hospital or entities. The imaging systems 100a, 100b, 100c . . . typically generate data sets which are stored in an associated database or library.

Associated with each of the imaging systems 100a, b, c . . . n is one or more computers such as personal computers or workstation computers 108a, b, c . . . n. The computers 108a, b, c . . . n include an operator interface which includes a human readable output such as a monitor or display and an operator input such as a keyboard and/or mouse.

The computer or computers associated with an imaging system 100 typically include at least one so-called operator console computer 108 through which the operator operates the imaging system. The operator console computer 108 typically includes modality and vendor-specific application software which allows a user to view and otherwise manipulate the information generated by the imaging system 100. Also associated with each imaging system 100 may be one or more so-called imaging workstation computers 108. The imaging workstation computers 108 may communicate with the imaging system 100 over a network separate from the network 106. The imaging workstation computers likewise include modality and vendor-specific application software which allows the user to view and otherwise manipulate information generated by the imaging system 100. In any case, the application software resident on the imaging workstation computers can be different from that resident on the operator console computers.

The PACS workstation computers 102a, b, c . . . n are in operative communication with a PACS server 110. The PACS server 110 typically stores information from one or more imaging systems in a common library or database so that the information stored on the server is available through the workstation computers 102. The PACS server 110 is typically in operative communication with and stores data from one or more imaging systems analogous to the imaging systems 100a, b, c . . . n. Resident on the PACS workstation computers 102a, b, c . . . n is typically application software which allows a user to view and otherwise manipulate the image and other information obtained from the PACS server 110. In some situations, the applications software may not be resident on the workstation computers 102a, b, c . . . n but may be obtained from the PACS server 110 on an as needed basis. The various devices or clients connected to the PACS system typically communicate via a suitable connection such as a local area network (LAN) or a wide area network (WAN).

The computers 104a, b, c . . . n may be standalone computers such as those located a physician's office or home or they may be connected to yet other computer networks.

The computer network 106 may be implemented via a local area network (LAN), wide area network (WAN), the internet, telephone lines, wireless networks, a satellite communications system or other communication system which allows communications between one or more computers. Using the network 106, a computer operatively connected to the network 106 can transfer data to at least one other computer which is operatively connected to the network 106. The various computers need not be continuously connected to the network 106 and may connect to the network 106 when needed to send or receive data. Information may be transferred by various techniques, for example through the use of e-mail attachments, internet based file servers, direct computer-to-computer communications, network drives, peer to peer file sharing software, or portable digital media such as CDs, DVDs, tapes, or memory sticks.

Turning now to FIG. 2, one or more medical imaging systems 200a, b, c . . . n, PACS system workstation computers 202a, b, c . . . n, and other computers 204a, b, c . . . n are operatively connected to PACS server 210 over a communications network such as a hospital or hospital group PACS network.

The imaging systems 200 are analogous to the imaging systems 100 discussed above in connection with FIG. 1 and typically include one or more operator console computers or imaging workstation computers 208. The PACS workstation computers 202 and other computers 204 are likewise analogous to the PACS workstation computers 102 and other computers 104 discussed above in connection with FIG. 1. One or more of the computers 202, 204, 208 may be located external to the PACS network and communicate with the PACS system via the internet or other suitable connection. While FIG. 2 shows one of the other computers 204n as being external to the network, computers such as one or more of the PACS workstation computers 202 or imaging system computers 208 may also be located external to the PACS network. In any case, the computers 208 are typically used to transfer images and other data from their associated imaging system 200 to the PACS server 210, and contain application software which allows a user to view and otherwise manipulate information generated by the associated imaging system 200. Similarly, the PACS workstation computers 202 and the other computers 204 typically include application software which allows a user to view or otherwise manipulate information stored on the PACS server 210, and may also include software which enables a user to transfer information to the PACS server 210.

With reference to both FIGS. 1 and 2, the computers 102, 104, 108, 202, 204, 208 are typically commercially available personal computers or workstation computers, such as computers utilizing the Intel Pentium processor and the Microsoft Windows operating system. Of course, other proprietary and non-proprietary computer configurations as well as other processors and operating systems may be implemented, depending on the vendor, the needs of a particular application, the characteristics of a particular computer, processor, or operating system, and other factors. In addition, the network configurations depicted in FIGS. 1 and 2 are exemplary, and other network configurations can be implemented.

The computer or computers 108, 208 associated with a particular imaging system 100, 200 typically include application software optimized for use with the modality in question. Thus, for example, a computer 108, 208 associated with an MR system typically has a different applications suite than a computer 108, 208 associated with a PET system. Where one or more of the imaging systems 100, 200 are provided by different vendors, the applications suites available on the associated computers 108, 208 are also likely to have different characteristics, even if their respective imaging systems 100, 200 are of the same modality. Even if the imaging systems 100, 200 are provided by the same vendor and are of the same modality, the associated computers 108, 208 may have different application suites, or the applications may be of different versions.

The PACS workstation computers 102, 202 are typically used to view or otherwise manipulate information generated by imaging systems 100, 200 of various modalities or which are provided by more than one vendor. Again, the application software available to the workstation computers 102, 202 may not be optimized for the capabilities of a particular imaging system vendor or modality, the applications suites may be different, or they may be of different versions.

The other computers 104, 204 may come from various vendors and have varying applications software available to them. As a result, the applications software resident on these computers can vary widely.

In any case, the software applications resident on any of the computers 102, 104, 108, 202, 204, 208 may be different from the application software resident on the others. This may cause difficulties where the user of one computer desires to share image data or other information with the user of another computer. Thus, for example, a user using a computer 108, 208 associated with a CT scanner may wish to transmit images or other information to the user of a computer 108, 208 associated with an MR scanner, a PACS workstation computer 102, 202, or another computer 104, 204 such as a computer located at a consulting physician's office or home. As another example, one of the computers 104, 204 may have specialized visualization software which is not resident on the computer associated with a particular imaging system 100, 200 or the computers 102, 202 associated with a PACS system. This information may not be known to, or readily ascertainable by, the user.

Moreover, having reviewed a particular data set, the user of one of the computers 102, 104, 108, 202, 204, 208, may find it desirable to ensure that the recipient has access to desired functionality for viewing or otherwise manipulating the data set, emphasize a particular portion of the data, or for the data to be presented in a particular way. This may be useful, for example, where the user would like to share the information with one or more colleagues for the purposes of collaboration, reporting, or additional or confirmatory analysis or measurements, with the patient, or with another third party. It may also be useful where the user would like to save the information for his or her own later use.

With reference to FIG. 3, data structure generation software 310 is resident on one or more of the computers 102, 104, 108, 202, 204, 208. More specifically, the software 310 is preferably included on a disk drive, volatile or non-volatile memory, or other computer readable storage media accessible to each the desired computers. The data structure generation software 310 includes instructions which, when executed by a computer, receive one or more input parameters 302 and generate a data structure 311 such as a computer readable file.

The input parameters 302 include one or more of application information 304, annotation information 305, presentation information 306, data set information 308, and access information 309. The data structure generation software 310 also has access to an application library 313 and an image database 321.

The application information 304 provides information indicative of the application software to be used to view or otherwise manipulate the information generated by an imaging system 100, 200. Thus, the application information 304 may be used to identify a desired software application available in the application library 313. The application information 304 may also be used to identify one or more functions within a particular application. This is particularly useful in situations where the user prefers that a recipient have access to only a subset of the functionality provided by the application. The software or the particular functions may be made identified explicitly by a user, or the identification may be made implicitly based on other factors.

The annotation information 305 includes notes or observations entered by a user based upon his or her evaluation of the data set. Such an annotation could include, for example, a diagnostic report relating to the data set. Such a report may include one or more of text relating to feature of interest (such as a known or suspected pathology), voice clips (sound files), measurements (including calculations, derived, or tabulated measurements), graphs, and tables. Annotation information may also include one or more markers or pointers which highlight features of particular interest in the data set, such as an arrow pointing to a suspected lesion.

The presentation information 306 is used to specify a desired presentation of the data set. In one embodiment, the presentation information is used to describe an initial presentation or display of the data set. The presentation information 306 may include values for one or more display parameters such as a desired gray scale, zoom factor, contrast, colors, rendering parameters, or the like. The presentation information 306 may also specify one or more key images which may be particularly relevant and which should be displayed first or otherwise highlighted. The presentation information 306 may also be used to specify an initial orientation for displaying the data. Thus, where the data set contains volumetric data, the presentation information 306 may be used to specify one or more of axial, sagittal, coronal, or multi-planar reformatted (MPR) images. Similarly, if a three dimensional rendered image is presented, the presentation information 306 may be used to specify a desired initial orientation and rendering settings for presenting the rendered image.

In another example, the data set includes an image series generated by medical imaging scanner as a result of a scan. In the case of a computed tomography scan, for example, the image series may contain a large number of axial image slices indicative of a patient's interior anatomy. The presentation information 306 may be used to specify the order in which the images are presented.

The presentation information 306 may also be used to specify a desired format or configuration for displaying the data set 312. Thus, for example, the user may wish to present each of axial, sagittal, coronal image slices, a three dimensional rendered image, and the values of one or more measurements or calculations in respective windows on a computer monitor or display.

In addition to describing an initial presentation of the data set, the presentation information 306 may also be used specify the subsequent presentation or display of the data set. In one example, a user may wish to specify how one or more of the initial presentation parameters should change with time. In another example, the user may wish to guide a recipient through the data set. Where the data set contains a number of image slices, for example, user may wish to define the order in which images are displayed. In an example which is particularly useful in the case of a volumetric data set, the user may wish the orientation of the displayed image to change with time, to define a progression of cutting planes though the image, or to specify how one or more of the rendering parameters should change with time. Where the user navigates through the data set, the presentation information 306 may be used to specify a desired path and/or orientation for the navigation.

Presentation of the image data is not confined to the presentation of images. Thus, the presentation information 306 may specify a presentation which includes other viewing, manipulation, or analysis functions provided by the application software.

Of course, the above are exemplary, and additional and different presentation information 306, as well as varying combinations of the information, can be implemented depending on the functionality provided by a particular software application, as well on user or application needs.

The data set information 308 is used to identify a data set of interest. The data set information 308 may include a series or accession number, URL, file name, patient name, or other demographic information which can be used to identify the data set.

The access information 309 is used where it is desirable to identify the intended recipients of a particular data, the computers on which the data set is likely to be accessed, or the like. The access information 309 may also include security related information such as a password or encryption information.

The data structure 311 generated by the data structure generation software 310 includes one or more of a data set 312, presentation data 316, annotation data 315, application software 316, an extractor program 320, and access data 322. To reduce the size of the data structure 311, some or all of the data structure 311 may be compressed. To enhance security, some or all of the data structure 311 may also be encrypted.

The extractor program 320 includes instructions which, when executed by a computer, extract the data set 312, presentation information 314, annotation information 315, and application software 318 from the data structure 311. Where the data structure 311 is compressed or encrypted, the extractor program 320 also includes suitable decompression and decryption functionality. Preferably, the extractor program 320 also loads the application software 318 into computer memory and causes the application software 318 to execute. One advantage of such an arrangement is that the data structure 311 appears to the recipient as a single structure or file, and the recipient need not be concerned with selecting appropriate application software, determining the desired functionality, or locating the desired data file. The information may also be compiled so that the data structure 311 takes the form of an executable file, such that an explicit extraction of or loading of the application software 318, data set 312, or other data is not required.

The generation software 310 uses the application information 304 to obtain the desired application software 316 from the application library 313. It also uses the presentation information 306 to generate the presentation data 314.

Similarly, the generation software 310 uses the data set information 308 to obtain a desired data set 312 from the image database 321.

The generation software also uses the annotation information 305 to generate the annotation data 315.

Of course, the data structure 311 may contain additional or different elements. Thus, for example, if a recipient is known to have access to a particular application software, the application software 318 could be omitted. In another embodiment, the data structure may include a DICOM compliant data set, together with DICOM compliant application software.

In any case, the application software 316 presents the data set 312 and annotation data 314 in accordance with the presentation data 314. Preferably, the application software 316 includes functionality which allows a user to deviate from the presentation defined by the presentation data 314. Thus, for example, if the recipient desires to focus more closely on a feature which the recipient finds particularly noteworthy, to view or manipulate the data set 312 in some other way or in another order, or to view a different portion of the data set 312, the recipient may do so. As another example, the application software 316 may also allow the recipient to alter existing annotations, add his or her own annotations, or perform additional manipulations or measurements on the data set 312. According to yet another example, the data set 312 may initially contain only a subset of the data available to the sender, such as those images which the sender believes to be the most important or key images. Similarly, the application software 316 may contain only a subset of the functionality otherwise available. The data structure 311 also contains a link to or address of the more complete data set and application software which provides the additional functionality. Should the recipient wish to access the more complete data set or use the additional functionality, the application software 316 retrieves the applicable data or functionality from the specified address or source, either automatically or at the request of the user.

While the generation software 310 has been described as a standalone software application, the generation software 310 may also be part of or accessed through another application which allows a user to view or otherwise manipulate image data. One advantage of such an arrangement is that one or more of the input parameters 302 may be established as a function of corresponding parameters being used by the other application. Thus, for example, the data set information 308 may be set to the data set being accessed by the other application. Similarly, some or all of the presentation information 306 may be established implicitly, for example by capturing a particular presentation of the data set or a series of such presentations as the user of the application views or otherwise manipulates the data set. Moreover, the application information 304 may default to the other application, to a subset of the functionality provided by the application, or to the functionality used by person creating the data structure 311 while viewing or otherwise manipulating the data set.

In another embodiment, still other of the input parameters 302 may be established implicitly. For example, some or all of the application information 304, annotation information 305, presentation information 306, data set information, or access information may be established based on the identity of the user creating the data structure 311, the identity of the intended recipient of the data structure 311, the anatomy covered by a particular data set, the acquisition protocol used by a medical imaging scanner to generate the data set 312, or other relevant criteria.

Thus, for example, if a user is currently accessing a particular data set using a particular application package, and is viewing a particular axial image from a series of such images, and intends to make the data set available to a particular recipient who is known to prefer certain contrast and brightness settings, the values of the relevant input parameters 302 can be established accordingly.

Turning now to FIG. 4, in operation, a user such as a physician uses application software resident on one of the computers 102, 104, 108, 202, 204, 208 to view or manipulate information relating to a particular patient or study at step 402.

At 404, the user accesses the data structure generation software 310.

The values of the relevant input parameters 302 are established at 406. As noted above, some or all of the values may be established explicitly by the user. Alternately, some or all may be established implicitly as a function of other variables.

At 408, the data structure generation software 310 receives the input parameter or parameters 302 and generates the data structure 311.

At 410, the data structure 311 is made available to the desired recipient or recipients, for example through computer network 106 or by storing the data structure on the PACS server 110.

At 412, a recipient receives the data structure 311 and activates the extractor program 320, for example by clicking on an icon indicative of the data structure 311 or otherwise instructing the computer's operating system to execute the data structure 311. Where the data structure 311 contains access data 322 such as a password or a restricted distribution list, the extractor/loader 320 requires the corresponding password or suitable authentication before extracting the data. Alternately, the information maybe required by the application software 316.

At 414, the application software 316 executes, using the data set 312. The application software 316 presents the information to the user in accordance with the presentation data 314 and the annotation data 315 so that the data set 312 is presented to the recipient in the matter specified when the data structure 311 was generated.

At 416, the recipient uses the application software 318 to view or otherwise manipulate the data set 312.

While the invention has been described in relation to medical image data, it will be appreciated that the invention is also applicable to images indicative of non-human animals and inanimate objects.

The invention has been described with reference to the preferred embodiments. Of course, modifications and alterations will occur to others upon reading and understanding the preceding description. It is intended that the invention be construed as including all such modifications and alterations insofar as they come within the scope of the appended claims or the equivalents thereof.

1. A method comprising:
receiving information indicative of desired medical image data (308), a desired presentation (306) of the medical image data, and a desired application software (304);
generating a computer readable data structure (311) which includes
the desired medical image data (312);
presentation data (314) which specifies the desired presentation of the medical image data (312);
the desired application software (316) wherein, in operation, the application software presents the desired medical image data (312) in human readable form in accordance with the presentation data (314).

2. The method of claim 1 wherein the data structure (311) is a self-extracting file.

3. The method of claim 1 wherein the medical image data (312) includes volumetric image data indicative of an interior anatomy of a patient.

4. The apparatus of claim 3 wherein the presentation data (314) includes an orientation for presenting the volumetric image data.

5. The apparatus of claim 4 wherein the presentation data (314) includes an orientation for presenting a multiplanar reformatted image.

6. The method of claim 3 wherein the presentation data (314) specifies the presentation of the volumetric image data as a function of time.

7. The method of claim 4 wherein, in operation, the application software (316) allows a user to deviate from the presentation specified by the presentation data (314).

8. The method of claim 1 wherein the step of receiving includes receiving presentation information (306) captured during a review of the data set.

9. The method of claim 1 wherein the medical image data (312) includes an image series generated by a medical imaging scanner and the presentation data (314) specifies an order for presenting images contained in the series.

10. The method of claim 1 wherein the information indicative of a desired application software (304) includes an anatomical region covered by the medical image data.

11. The method of claim 1 further including transmitting the data structure over a computer network.

12. The method of claim 1 wherein the information indicative of the desired presentation (306) includes an acquisition protocol used by a medical imaging scanner to acquire the medical image data.

13. The method of claim 1 wherein the medical image data is a subset of the data for a particular patient and wherein the data structure includes a computer-readable address for obtaining additional medical image data relating to the patient.

14. An apparatus comprising:
means (310) for receiving information indicative of desired medical image data (308), a desired presentation (306) of the medical image data, and a desired application software (304);
means (310) for generating a computer readable data structure (311) which includes
the desired medical image data (312);
presentation data (314) indicative of a desired presentation of the medical image data (312);
application software (316) which, in operation, presents the desired medical image data (312) in human readable form in accordance with the presentation data (314).

15. A computer readable storage medium containing instructions which, when executed by a computer, carry out a method comprising:
obtaining image data (312) indicative of an interior of an object;
generating presentation data (314) which specifies a desired presentation of the image data (312);
obtaining application software (316) which, in operation, presents the image data (312) to a human user in accordance with the presentation data (314);
generating a data structure (311) which includes the image data (312), the presentation data (314), and the application software (316).

16. The computer readable storage medium of claim 15 wherein the image data (312) includes volumetric image data and wherein the application software (316) presents a three dimensional representation of the image data.

17. The computer readable storage medium of claim 16 wherein the presentation data (314) includes a path for navigating the three dimensional representation.

18. The computer readable storage medium of claim 15 wherein the method further includes identifying application software used by a user to manipulate the image data and wherein the step of obtaining application software includes obtaining the identified application software.

19. The computer readable storage medium of claim 18 wherein the application software (316) includes a plurality of functions, wherein the method includes identifying a function used by a user to manipulate the image data, and wherein the step of obtaining the identified application software includes obtaining the identified function of the application software.

20. The computer readable storage medium of claim 15 wherein the step of obtaining image data includes obtaining the image data (312) from a computer readable storage medium.

21. The computer readable storage medium of claim 15 wherein the step of obtaining application software includes obtaining application software selected by a user.

22. The computer readable storage medium of claim 15 wherein the presentation data (314) specifies a desired presentation of the image data as a function of time.

23. The computer readable storage medium of claim 15 wherein the application software (316) allows a user to deviate from the desired presentation.

24. The computer readable storage medium of claim 15 wherein the data structure (311) is contained in single computer file.

25. The computer readable storage medium of claim 24 wherein the computer file is a self-executing file.

26. The computer readable storage medium of claim 15 wherein the image data includes an image series generated by a medical image scanner.

27. The computer readable storage medium of claim 16 wherein the data structure includes a computer-readable address for obtaining application software not included in the data structure.
